(19) United States
(12) Patent Application Publication
(10) Pub. No.: US 2024/0415062 A1
(43) Pub. Date: Dec. 19, 2024

(54) DEVICE FOR CONTROLLING AT LEAST ONE PIECE OF AGRICULTURAL MACHINERY THAT IS MOVABLE WITHIN AN AGRICULTURAL PLOT

(71) Applicant: KUHN SAS, Saverne (FR)

(72) Inventors: Marie HOELLINGER, Rimling (FR); Philippe POTIER, Zittersheim (FR)

(73) Assignee: KUHN SAS, Saverne (FR)

(21) Appl. No.: 18/706,429

(22) PCT Filed: Nov. 3, 2022
(86) PCT No.: PCT/EP2022/080703

§ 371 Date: May 1, 2024

(30) Foreign Application Priority Data
Nov. 5, 2021 (FR) FR2111751

(51) Int. Cl. A01D 75/18; G05D 1/246; G05D 1/248

(52) U.S. Cl. CPC A01D 75/185; G05D 1/246; G05D 1/248

(57) ABSTRACT

A device for controlling a piece of agricultural machinery that is movable within an agricultural plot includes: a piece of machinery and a unit having a memory including input data for mapping a risk area located within an agricultural plot. The memory includes data representative of a set of types of risk area and data representative of a set of specific behaviors. The unit is configured to: associate the input data for mapping a risk area with a category, associate the category with a specific behavior of the piece of mobile agricultural machinery, and control the specific behavior if the position of the piece of machinery is located in or near the risk area. The piece of machinery is arranged to move autonomously within the agricultural plot according to the specific behavior controlled by the unit.

The present invention relates to the field of control devices for at least one mobile agricultural vehicle in a plot of land and to the methods implementing such devices.

A plot of land usually comprises one or more zones known to the farmer in which a mobile agricultural vehicle or a tool associated with a mobile agricultural vehicle must not go and/or not work and/or act differently. These zones known to the farmer will be referred to as risky zones in the following description.

Currently, the behavior of the mobile agricultural vehicle within the plot of land is adjusted manually by the person driving the mobile agricultural vehicle. For example, if there is an obstacle in the plot of land, the driver will steer round it. In other situations, the driver may for example need to adjust the tool based on the zone of the plot of land on which he is working. As a result, the person driving the mobile agricultural vehicle cannot work under optimal conditions, as he is required to focus on the various risks he encounters within the plot of land, requiring him to work more slowly in most cases. There is also a risk that the driver may forget to make an adjustment, which can lead to a poorer quality of work and therefore sub-optimal yield.

Within a plot of land, the person driving the mobile agricultural vehicle may be required to carry out with his mobile agricultural vehicle the following agricultural operations, given as non-limiting examples: soil-working (plowing, tillage, etc.), seeding, weeding, hoeing, spreading, spraying of liquid or solid fertilizer or plant protection products, harvesting (harvest, silage, etc.), mowing, tedding, windrowing, baling, etc.

Within a plot of land, the person driving the mobile agricultural vehicle may come across the following risky zones, given as non-limiting examples: watercourses, electric poles, roadsides, housing, wet zones, stony zones, irrigation channels, etc.

Within a plot of land, the person driving the mobile agricultural vehicle may have to make the mobile agricultural vehicle adopt the following specific behaviors, given as non-limiting examples: slowing down in the vicinity of an obstacle, reducing the working depth in a zone in which the soil is “heavy”, cutting off fertilizer distribution alongside rivers, reducing the working speed in slopy zones to reduce the risk of overturning, etc.

The different behaviors may also be specific to an operation or a season, or even to the day on which the work is carried out. For example, if a tree has fallen in the plot, it will have to be taken into account on the day of the operation, but not necessarily the following time, as it may have been cleared by then.

Specific behavior may also be imposed by applicable legislation. In Germany, for example, legislation prohibits the distribution of fertilizers alongside watercourses over a given width.

A system and a method for assisting the driver of the mobile agricultural vehicle when working on a plot of land, in which tool depth prescription maps for an agricultural vehicle are used are already known from publication US2020113123A1. This solution has the drawback of being limited to optimizing the tool depth in one plot of land.

A system and a method for assisting the driver of the mobile agricultural vehicle when working on a plot of land, making it possible to determine an optimized path to be followed by an agricultural vehicle during work on a plot of land, particularly if an obstacle is present in the plot of land are already known from publication EP3518647B1. This solution has the drawback of being limited to optimizing the path of the agricultural vehicle in one plot of land.

The present invention aims to overcome at least one of these drawbacks and to provide a solution that enables a mobile agricultural vehicle to take account of different types of risky zones when working autonomously on a plot of land, so that it can adjust its behavior according to its environment to optimize the work.

The invention relates to a device according to claim 1.

The invention also relates to a method according to claim 12.

The invention will be better understood through the following description, which refers to several preferred embodiments given as non-limiting examples and explained with reference to the attached schematic drawings, in which:

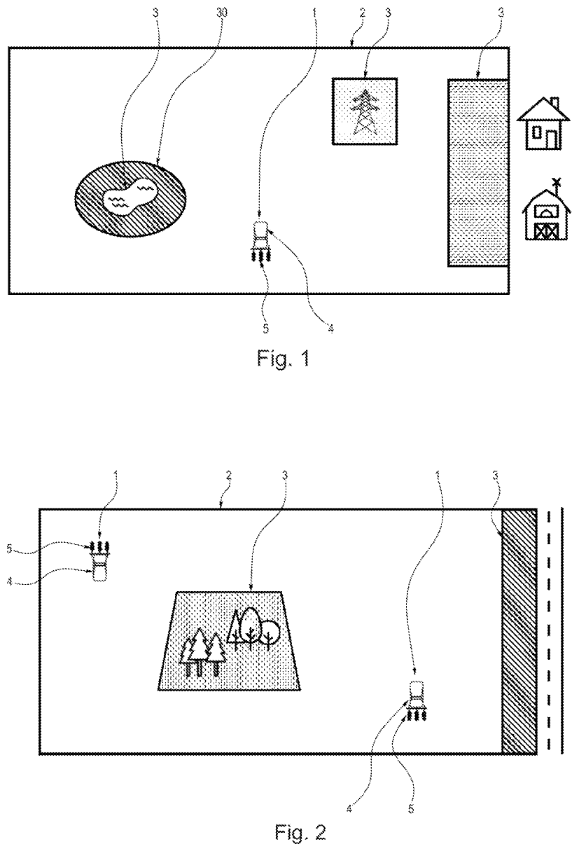

FIG. 1 shows a first possibility of a plot of land comprising three risky zones and within which an agricultural vehicle with the control device according to the invention moves, during an autonomous movement stage in accordance with the method according to the invention;

FIG. 2 shows a second possibility of a plot of land comprising two risky zones and within which two agricultural vehicles with the control device according to the invention move, during the autonomous movement stage in accordance with the method according to the invention;

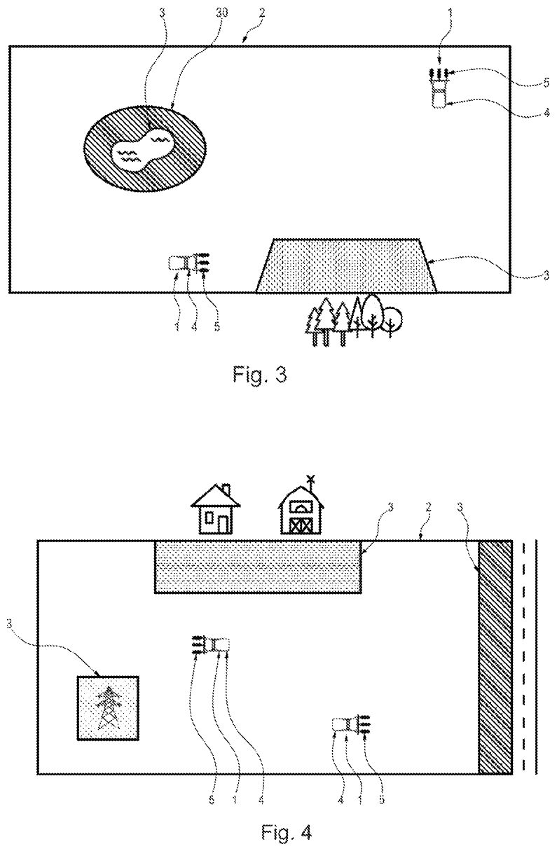

FIG. 3 shows a third possibility of a plot of land comprising two risky zones and within which two agricultural vehicles with the control device according to the invention move, during the autonomous movement stage in accordance with the method according to the invention;

FIG. 4 shows a fourth possibility of a plot of land comprising three risky zones and within which two agricultural vehicles with the control device according to the invention move, during the autonomous movement stage in accordance with the method according to the invention;

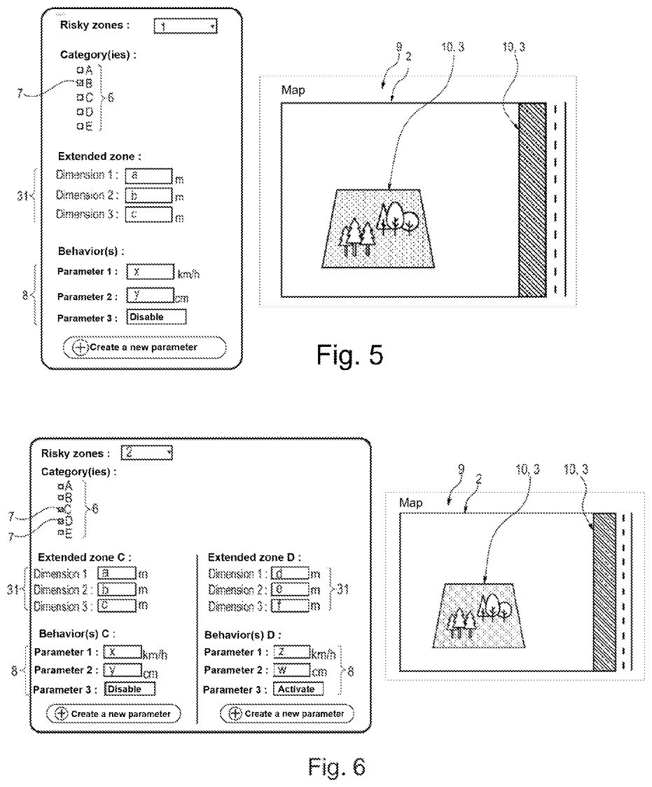

FIG. 5 shows a map of the plot of land shown in FIG. 2 and the data relating to a first risky zone, which are displayed on a screen of the control device according to the invention; and

FIG. 6 shows a map of the plot of land shown in FIG. 2 and the data relating to a second risky zone, which are displayed on the screen of the control device according to the invention.

A control device for at least one agricultural vehicle 1 mobile within a plot of land 2, comprises at least:
one mobile agricultural vehicle 1 comprising at least one localization element, e.g. a GPS;
a processing and control unit comprising at least one storage device, said at least one storage device comprising at least input data for mapping of at least one risky zone 3 located within at least one plot of land 2.

In accordance with the invention, said device is characterized:
in that said storage device includes at least data representative of a set of types of risky zones 3 called categories and data representative of a set of specific behaviors of said at least one mobile agricultural vehicle 1;
in that said processing and control unit is configured to associate the input data for mapping of at least one risky zone 3 with at least one category;
in that said processing and control unit is configured to associate said at least one category with at least one specific behavior of said at least one mobile agricultural vehicle 1;
in that said processing and control unit is configured to control said at least one specific behavior for said mobile agricultural vehicle 1, if the position of said agricultural vehicle 1 is located in or near said at least one risky zone 3;
in that said mobile agricultural vehicle 1 is arranged to move autonomously within the plot of land 2 according to said at least one specific behavior controlled by said processing and control unit.

Advantageously, when a risky zone 3 is demarcated in the plot of land 2 using the input data for mapping, the processing and control unit associates at least one category with it. In addition, the processing and control unit associates at least one specific behavior with said at least one category. In this way, the processing and control unit can control said at least one mobile agricultural vehicle 1 to adopt at least one specific behavior in the risky zone 3, for example by means of at least one control signal. Said at least one specific behavior is applied automatically and autonomously by said at least one mobile agricultural vehicle 1 according to its position in the plot of land 2. The control device according to the invention therefore advantageously allows said at least one mobile agricultural vehicle 1 to operate in a completely autonomous way, in other words without human intervention, in the plot of land 2, by adjusting its behavior effectively according to its environment, in other words taking into account risky zones 3 located in the plot of land 2, so as to optimize work in the plot of land 2. In addition, the various specific behaviors are applied by said at least one mobile agricultural vehicle 1 automatically according to its position in the plot of land 2. This configuration according to the invention improves the guidance precision of said at least one mobile agricultural vehicle 1 in the plot of land 2 containing one or more risky zones 3. It also makes it possible to simplify the implementation and automate the behaviors required for the work of said at least one mobile agricultural vehicle 1 in the plot of land 2, such as for example the protection of said at least one mobile agricultural vehicle 1, the optimization of the work of said at least one mobile agricultural vehicle 1 (dose, depth, etc.) and compliance with the current regulations.

Example 1: if the risky zone 3 is categorized as a housing frontage and the agricultural operation to be carried out by the mobile agricultural vehicle 1 is a plant protection treatment, then the processing and control unit of the control device according to the invention will automatically control the mobile agricultural vehicle 1 to cut off the distribution of these products in the defined risky zone 3, as a specific behavior.

Example 2: if the risky zone 3 is identified as a body of water (lake, pond, etc.), then the risky zone 3 is associated with a category that corresponds to an unsurmountable obstacle for the mobile agricultural vehicle 1, and the processing and control unit of the control device according to the invention will automatically control the mobile agricultural vehicle 1 to perform the specific behavior consisting of not working in the defined risky zone 3, regardless of the type of agricultural operation being carried out.

Example 3: if the risky zone 3 is identified as an irrigation channel, then the risky zone 3 is associated with a category that corresponds to a surmountable obstacle for the mobile agricultural vehicle 1, and the processing and control unit of the control device according to the invention will automatically control the mobile agricultural vehicle 1 to perform the specific behavior consisting of not working in the defined risky zone 3, regardless of the type of agricultural operation being carried out.

Preferably, said processing and control unit is configured to control said at least one specific behavior for said mobile agricultural vehicle 1, if the position of said agricultural vehicle 1 is located strictly within said at least one risky zone 3 and said mobile agricultural vehicle 1 is arranged to move autonomously within said at least one risky zone 3 according to said at least one specific behavior controlled by said processing and control unit.

For example, in the case of a slopy type risky zone 3, the mobile agricultural vehicle 1 only adopts the specific behavior when it enters the real closed outline of the slopy risky zone 3.

Alternatively and preferably, said processing and control unit is configured to control said at least one specific behavior for said mobile agricultural vehicle 1, if the position of said agricultural vehicle 1 is near said at least one risky zone 3 and said mobile agricultural vehicle 1 is arranged to move autonomously in the vicinity of said at least one risky zone 3 according to said at least one specific behavior controlled by said processing and control unit.

Advantageously, the mobile agricultural vehicle 1 adopts the specific behavior when approaching or near the risky zone 3. For this purpose, distance values defining the proximity of the risky zone 3 can be set automatically by the robot according to the selected/imposed category and/or behavior, or by the user.

Alternatively and preferably, said at least one storage device comprises at least input data for mapping of at least one extended zone 30 around said at least one risky zone 3, said processing and control unit is configured to control said at least one specific behavior for said mobile agricultural vehicle 1, if the position of said agricultural vehicle 1 is located in said at least one extended zone 30 around said at least one risky zone 3 and said mobile agricultural vehicle 1 is arranged to move autonomously within said at least one extended zone 30 according to said at least one specific behavior controlled by said processing and control unit.

In addition to the data for mapping defining the real or specific closed outline of the risky zone 3, it is additionally possible to define an extended zone 30 of the risky zone 3, which can also be demarcated by an extended closed outline larger than the real or specific closed outline of the risky zone 3. The real closed outline lies within the extended closed outline of the risky zone 3. This is particularly advantageous when certain categories are selected, e.g. an unsurmountable obstacle. For example, FIG. 1 shows an extended zone 30 which corresponds substantially to the hatched zone around the obstacle, namely a pond in the illustrated example. In this extended zone 30, the mobile agricultural vehicle 1 adopts at least the specific behavior controlled. In the case of an unsurmountable obstacle, this allows the agricultural vehicle 1 to slow down as it approaches the obstacle and not brake suddenly in front of it. This extended zone 30 can be defined automatically on the basis of the outline surveyed by the robot or by the user, in other words the geometric shape of the extended zone 30 and its dimensions.

Preferably, said processing and control unit is connected to a human-machine interface described below and the processing and control unit is configured to display on said human-machine interface the input data for mapping of at least one extended zone 30. Input data for mapping of at least one extended zone 30 can be entered and then displayed on a screen, for example in the form of a list of parameters 31 as illustrated in FIGS. 5 and 6.

In practice, to control said at least one specific behavior for said mobile agricultural vehicle 1, if the position of said agricultural vehicle 1 is inside or near said at least one risky zone 3, the processing and control unit is preferably configured to send at least one control signal representative of the specific behavior to the mobile agricultural vehicle 1. For its part, said mobile agricultural vehicle 1 is configured to process the control signal representative of the specific behavior, so as to move in the plot of land 2 or in the risky zone 3 by adopting the specific behavior. Preferably, transmitting/receiving the control signal between the processing and control unit and said mobile agricultural vehicle 1 takes place remotely by wireless communication means, for example of the radiofrequency type. This configuration is preferred when the processing and control unit and said mobile agricultural vehicle 1 are two separate and distinct entities, distant from each other.

A mobile agricultural vehicle 1 is defined as an agricultural vehicle 4 or an agricultural vehicle 4 associated with at least one agricultural tool 5 or an agricultural vehicle 4 incorporating at least one agricultural tool 5. The mobile agricultural vehicle 1 can be autonomous, in other words it does not require the intervention of a driver to move around the plot of land 2 and/or carry out an operation in the plot of land 2. The autonomous mobile agricultural vehicle 1 can be an agricultural robot. Said at least one mobile agricultural vehicle 1 may consist, for example, of a fleet of mobile agricultural vehicles 1.

A plot of land 2 is defined as an agricultural zone demarcated by a preferably closed outline, as illustrated in FIGS. 1 to 4.

A processing and control unit is defined as a programmable information processing system. The processing and control unit can be remote and consist, for example, of a computer or a tablet or a smartphone. Alternatively, the processing and control unit can form part of the mobile agricultural vehicle 1. As the processing and control unit is programmable, it can include at least one software. The processing and control unit enables at least the transmission of said at least one control signal to said at least one agricultural vehicle 1 and thus performs a control function. The processing and control unit also enables at least the above-mentioned different types of data to be associated with each other, and thus performs a data processing function. The processing and control unit can comprise a control sub-system that performs the control function and a separate processing sub-system that performs the processing function. Alternatively, the processing and control unit can comprise a single processing and control system that performs both the processing function and the control function.

A risky zone 3 is defined as a closed outline within the plot of land 2, as illustrated in FIGS. 1 to 4.

According to a first possibility shown in FIG. 1, the plot of land 2 comprises three risky zones 3, namely a risky zone 3 of the “pond” type, a risky zone 3 of the “electric pole” type and a risky zone 3 of the “housing frontage” type.

According to a second possibility shown in FIG. 2, the plot of land 2 comprises two risky zones 3, namely a risky zone 3 of the “forest” type and a risky zone 3 of the “roadside” type.

According to a third possibility shown in FIG. 3, the plot of land 2 comprises two risky zones 3, namely a risky zone 3 of the “pond” type and a risky zone 3 of the “forest edges” type.

According to a fourth possibility shown in FIG. 4, the plot of land 2 comprises three risky zones 3, namely a risky zone 3 of the “pond” type and a risky zone 3 of the “forest edges” type.

The input data for mapping of at least one risky zone 3 may consist of geographical or GPS coordinates. The input data for mapping can be obtained during the survey of the plot of land 2, and can be manually collected and sent to the processing and control unit. The input data for mapping can alternatively be demarcated by a user on a map of the plot of land 2 displayed by a human-machine interface, such as a screen, included in the control device according to the invention. In this case, the user demarcates at least one closed outline on the map of the plot of land 2 displayed on the screen. In this case, for example, the risky zone 3 can be entered manually by the operator by a points input or by drawing polygons by hand. Input data for mapping of at least one risky zone 3 is entered into the processing and control unit, ideally before the mobile agricultural vehicle 1 starts operating in the plot of land 2. If one wishes to add or change data representative of a set of types of risky zone 3 during the autonomous agricultural operation, the entire agricultural operation is preferably stopped for said at least one mobile agricultural vehicle 1. An alternative solution to stopping the agricultural operation completely would be to allow the user to add or change data representative of a set of types of risky zone 3 during the autonomous agricultural operation, as long as no agricultural vehicle 1 has reached the risky zone 3 to be modified. This solution would enable “on the go” adjustment of risky zones 3, while limiting the risk of conflicts and inconsistencies caused by changing a risky zone 3 just before, during or after working on it with an agricultural vehicle 1.

Data representative of a set of types of risky zones 3, called categories, is defined as information on the typology or nature of the risky zone 3. For example, this data may be in the form of a database or a library. Therefore, and by way of example, data representative of a set of categories may include the following non-exhaustive list: roadsides, housing frontage, forest edges, surmountable obstacle, unsurmountable obstacle, stony zone, clay zone, slopy zone, and so on. For example, an unsurmountable obstacle could be a body of water or a fallen tree in the plot of land 2. For example, a surmountable obstacle may correspond to an irrigation channel. Data representative of a set of types of risky zones 3 called categories is ideally entered into the storage device of the processing and control unit before the mobile agricultural vehicle 1 starts operating in the plot of land 2. If one wishes to add or change data representative of a category during the autonomous agricultural operation, the entire agricultural operation is stopped for said at least one mobile agricultural vehicle 1. A risky zone 3 can be characterized by one or more categories combined, for example: slopy and roadside.

Data representative of a set of specific behaviors of said at least one mobile agricultural vehicle 1 is defined as information on the agricultural operation to be carried out or not by the mobile agricultural vehicle 1 and/or information on its travel path or its advance speed. For example, this data may be in the form of a database or a library. Therefore, and by way of example, data representative of a set of specific behaviors may include the following non-exhaustive list: slowing down in the vicinity of an obstacle, reducing the working depth in a zone in which the soil is “heavy”, cutting off fertilizer distribution alongside rivers, reducing the working speed in a slopy zone, etc. Specific behaviors may concern only the agricultural vehicle or only the agricultural tool or agricultural tools associated with it. A combination of actions on both sets, for the agricultural vehicle and the agricultural tool(s), is also possible. Data representative of a set of specific behaviors is ideally entered into the storage device of the processing and control unit before the mobile agricultural vehicle 1 starts operating in the plot of land 2. If one wishes to add or change data representative of specific behavior during the autonomous agricultural operation, the entire agricultural operation is preferably stopped for said at least one mobile agricultural vehicle 1.

Preferably, said processing and control unit is configured to associate the input data for mapping of at least one risky zone 3 with at least one category based on selection instructions received from a user or from a robot consisting of selecting at least one category said to be selected from a set of possible predefined categories for said at least one risky zone 3 or from a set of additional categories not contained in said set of possible predefined categories for said at least one risky zone 3.

Advantageously, a user or a robot can select at least one category said to be selected from a set of possible predefined categories for said at least one risky zone 3, or alternatively from a set of additional categories not contained in said set of possible predefined categories for said at least one risky zone 3. This provides the user or the robot with a predefined library or an additional library if they wish to select a particular category, in addition to those already provided, as the selected category. The processing and control unit is configured to associate the input data for mapping of at least one risky zone 3 with said at least one category said to be selected, which has been selected by the user or the robot. In this case, said set of possible predefined categories or said set of additional categories is proposed to the user or the robot, who will validate them or not at the time of categorization.

Preferably, said processing and control unit is connected to a human-machine interface and the processing and control unit is configured to display on said human-machine interface at least said set of possible predefined categories for said at least one risky zone 3.

The human-machine interface can include at least a keyboard and/or a mouse and/or a touchpad and/or a screen. The human-machine interface may be a separate entity from the processing and control unit, or may form part of it.

In this case, said set of possible predefined categories or said set of additional categories is proposed to the user or robot via the human-machine interface. As illustrated in FIGS. 5 and 6, this allows, for example, a list 6 representative of said set of possible predefined categories or said set of additional categories to be displayed on a screen for each of the two risky zones 3. From this list 6 displayed on the screen, the user or the robot can select said at least one category said to be selected. To do this, the user or the robot can, for example, check a box associated with the category said to be selected. A checked box 7 associated with the category said to be selected may be displayed on the screen, as illustrated in FIGS. 5 and 6. In the examples in FIGS. 5 and 6, the list 6 representative of said set of possible predefined categories comprises a set of five categories A, B, C, D and E. In the example in FIG. 5, for the first risky zone 3, a single category is selected by the user or the robot from the list 6, and is displayed on the screen in the form of a checked box 7 in front of category B. In the example in FIG. 6, for the second risky zone 3, two categories are selected by the user or the robot from the list 6 and are displayed on the screen as two checked boxes 7 in front of categories C and D respectively.

Preferably, said human-machine interface is configured to send to the processing and control unit said at least one category selected by said user.

Advantageously, thanks to this configuration, said at least one category said to be selected by the user or the robot can be sent to the processing and control unit.

Preferably, said processing and control unit is configured to associate said at least one selected category with at least one specific behavior of said at least one mobile agricultural vehicle 1 based on instructions received by a user or a robot consisting of selecting at least one specific behavior said to be selected from a set of possible specific behaviors for said at least one selected category or from a set of additional specific behaviors not contained in said set of possible specific behaviors for said at least one selected category.

Advantageously, a user or a robot can select at least one specific behavior said to be selected from a set of possible specific behaviors for said at least one selected category, or from a set of additional specific behaviors not contained in said set of possible specific behaviors for said at least one selected category. This provides the user or the robot with a predefined library or an additional library if they wish to select a particular specific behavior, in addition to the specific behaviors already provided, as the specific behavior said to be selected. The processing and control unit is configured to associate said at least one category said to be selected with at least one specific behavior said to be selected following a selection operation performed by the user or the robot. In this case, said set of possible specific behaviors or said set of additional specific behaviors is proposed to the user or robot, who will validate them or not.

In this case, said processing and control unit is preferably connected to a human-machine interface and the processing and control unit is configured to display on said human-machine interface at least said set of possible specific behaviors that can be associated with said at least one selected category.

This human-machine interface is preferably as described above and thus enables, for example, a list representative of said set of possible specific behaviors or said set of additional specific behaviors for said at least one selected category to be displayed on a screen. From this list, the user or robot can select said at least one specific behavior said to be selected. Said at least one specific behavior said to be selected can be entered and then displayed on the screen, for example in the form of a list of parameters 8 for each specific behavior selected. In the example in FIG. 5, the list of parameters 8 for a single selected specific behavior referred to as “behavior(s)” and which is associated with category B includes a first parameter, referred to as “parameter 1”, relating to the speed of the agricultural vehicle 1, a second parameter, referred to as “parameter 2”, relating to the working depth, and a third parameter, referred to as “parameter 3”, relating to the operation of a system for distributing agricultural products such as seeds, fertilizers or plant protection products by the agricultural vehicle 1. In the example in FIG. 6, the list of parameters 8 for a first selected specific behavior referred to as “behavior(s) C”, which is associated with category C, includes a first parameter, referred to as “parameter 1”, relating to the speed of the agricultural vehicle 1, a second parameter, referred to as “parameter 2”, relating to the working depth, and a third parameter, referred to as “parameter 3”, relating to the operation of a system for distributing agricultural products such as seeds, fertilizers or plant protection products by the agricultural vehicle 1. In the example in FIG. 6, the list of parameters 8 for a second selected specific behavior referred to as “behavior(s) D”, which is associated with category D, includes a first parameter, referred to as “parameter 1”, relating to the speed of the agricultural vehicle 1, a second parameter, referred to as “parameter 2”, relating to the working depth, and a third parameter, referred to as “parameter 3”, relating to the operation of a system for distributing agricultural products such as seeds, fertilizers or plant protection products by the agricultural vehicle 1.

Preferably, said human-machine interface is configured to send to the processing and control unit said at least one specific behavior said to be selected by said user.

Advantageously, thanks to this human-machine interface, said at least one specific behavior said to be selected, which has been selected by the user or the robot, can be sent to the processing and control unit.

Preferably, said processing and control unit is configured to store in said at least one storage device at least one specific behavior said to be selected, associated with said input data for mapping.

Advantageously, this storage makes it possible for the mobile agricultural vehicle 1 to be subsequently controlled again to perform the same specific behavior said to be selected if the same risky zone 3 is encountered again in the same plot of land 2. This storage can be temporary or permanent. For example, if the risky zone 3 is associated with a temporary event, such as a temporary weather-related obstacle: a fallen tree and/or a wet zone in the plot of land 2, then the storage of the specific behavior selected will be temporary, since it is more likely that this temporary obstacle will no longer be present in the plot of land 2 the next time.

However, if the risky zone 3 is associated with a permanent event, for example a permanent hazard such as a slopy zone in the plot of land 2, then the storage of the specific behavior selected will be permanent, since it is more likely that this hazard will still be present in the plot of land 2 the next time.

Alternatively, said processing and control unit is configured to associate said at least one selected category with at least one specific behavior of said at least one mobile agricultural vehicle 1, based on automated instructions consisting of imposing at least one specific behavior said to be imposed from a set of possible specific behaviors for said at least one selected category.

Advantageously, in this case, it is not the user or the robot that selects said at least one specific behavior. Instead, the processing and control unit is configured to associate said at least one category said to be selected with at least one specific behavior said to be imposed, without any possible intervention by the user or the robot. This imposed specific behavior may therefore correspond to a specific behavior imposed by current legislation, such as an environmental regulation that must be respected. In some countries, for example, legislation prohibits the distribution of fertilizers alongside watercourses over a given width. Another example involves limiting a dose of agricultural product (such as fertilizer or crop protection product) in order to comply with specific legislation. In this case, the imposed behavior limits the maximum dose of the input to be distributed according to the law. The processing and control unit may, for example, include a database integrating the different legislation specific to certain geographical areas. The GPS position of the plot to be worked can then be correlated with this database to apply the imposed behaviors if necessary.

Preferably, the processing and control unit is connected to at least one human-machine interface comprising a screen, and the processing and control unit is configured to display on said screen at least one map 9 of the plot of land 2 comprising at least one real closed outline 10 of the risky zone 3 and/or one extended closed outline of the extended zone 30 and said at least one selected category.

Advantageously, this configuration enables the user or the robot to view on the screen at least one map of the plot of land 2 comprising a closed outline of the risky zone 3 and said at least one selected category. As illustrated in FIGS. 5 and 6, the map 9 of the plot of land displayed on the screen shows two risky zones 3, each demarcated by a closed outline 10.

The invention also concerns a control method for at least one agricultural vehicle 1 mobile within a plot of land 2.

In accordance with the invention, the process is implemented by the device according to the invention and as previously described, and comprises at least the following stages:
a risky zone 3, category and specific behavior storage stage, during which input data for mapping at least one risky zone 3 located within at least one plot of land 2, data representative of a set of types of the risky zone 3 called categories and data representative of a set of specific behaviors of said at least one mobile agricultural vehicle 1 are saved in at least one storage device contained in a processing and control unit of the device;
a first data association stage, during which said input data for mapping of at least one risky zone 3 is associated with at least one category by said processing and control unit;
a second data association stage, during which said at least one category is associated with at least one specific behavior of said at least one mobile agricultural vehicle 1 by said processing and control unit;
a control stage of the agricultural vehicle 1, during which said processing and control unit controls said specific behavior for said mobile agricultural vehicle 1 if the position of said agricultural vehicle 1 is within or near said at least one risky zone 3;
an autonomous moving stage of the agricultural vehicle 1 in the plot of land 2, during which said mobile agricultural vehicle 1 moves autonomously within the plot of land 2 according to said at least one specific behavior controlled by said processing and control unit (FIGS. 1 to 4).

Preferably, during the first data association stage, said processing and control unit associates the input data for mapping of at least one risky zone 3 with at least one category based on selection instructions received by a user or a robot, consisting of selecting at least one category said to be selected from a set of possible predefined categories for said at least one risky zone 3 or from a set of additional specific behaviors not contained in said set of possible specific behaviors for said at least one selected category.

Preferably, during the second data association stage, said processing and control unit associates said at least one selected category with at least one specific behavior of said at least one mobile agricultural vehicle 1 based on instructions received by a user or a robot, consisting of selecting at least one specific behavior said to be selected from a set of possible specific behaviors for said at least one selected category or from a set of additional specific behaviors not contained in said set of possible specific behaviors for said at least one selected category.

Alternatively, during the second data association stage, said processing and control unit associates said at least one selected category with at least one specific behavior of said at least one mobile agricultural vehicle 1, based on automated instructions consisting of imposing at least one specific behavior said to be imposed from a set of possible specific behaviors for said at least one selected category.

Obviously, the invention is not limited to the embodiments described and shown in the attached drawings. Modifications remain possible, in particular as regards the composition of the various elements or the substitution by technical equivalents without departing from the scope of protection of the invention.

1. A control device for at least one agricultural vehicle mobile within a plot of land, said device comprising at least:
one mobile agricultural vehicle comprising at least one localization element, e.g. a GPS;
a processing and control unit comprising at least one storage device, said at least one storage device comprising at least input data for mapping of at least one risky zone located within at least one plot of land;
wherein said storage device includes at least data representative of a set of types of risky zones called categories and data representative of a set of specific behaviors of said at least one mobile agricultural vehicle,
wherein said processing and control unit is configured to associate the input data for mapping of at least one risky zone with at least one category,
wherein said processing and control unit is configured to associate said at least one category with at least one specific behavior of said at least one mobile agricultural vehicle,
that wherein said processing and control unit is configured to control said at least one specific behavior for said mobile agricultural vehicle, if the position of said agricultural vehicle is located within or near said at least one risky zone,
wherein said mobile agricultural vehicle is arranged to move autonomously within the plot of land according to said at least one specific behavior controlled by said processing and control unit.

2. The device according to claim 1, wherein said at least one storage device comprises at least input data for mapping of at least one extended zone around said at least one risky zone, and wherein said processing and control unit is configured to control said at least one specific behavior for said mobile agricultural vehicle, if the position of said agricultural vehicle is located in said at least one extended zone around said at least one risky zone, and wherein said mobile agricultural vehicle is arranged to move autonomously within said at least one extended zone according to said at least one specific behavior controlled by said processing and control unit.

3. The device according to claim 1, wherein said processing and control unit is configured to associate the input data for mapping of at least one risky zone with at least one category based on selection instructions received from a user or from a robot consisting of selecting at least one category said to be selected from a set of possible predefined categories for said at least one risky zone or from a set of additional categories not contained in said set of possible predefined categories for said at least one risky zone.

4. The device according to claim 3, wherein said processing and control unit is connected to a human-machine interface and in that the processing and control unit is configured to display on said human-machine interface at least said set of possible predefined categories for said at least one risky zone.

5. The device according to claim 4, wherein said human-machine interface is configured to send to the processing and control unit said at least one category selected by said user.

6. The device according to claim 3, wherein said processing and control unit is configured to associate said at least one selected category with at least one specific behavior of said at least one mobile agricultural vehicle based on instructions received by a user or a robot consisting of selecting at least one specific behavior said to be selected from a set of possible specific behaviors for said at least one selected category or from a set of additional specific behaviors not contained in said set of possible specific behaviors for said at least one selected category.

7. The device according to claim 6, wherein said processing and control unit is connected to a human-machine interface and in that the processing and control unit is configured to display on said human-machine interface at least said set of possible specific behaviors which can be associated with said at least one selected category.

8. The device according to claim 7, wherein said human-machine interface is configured to send to the processing and control unit said at least one specific behavior said to be selected by said user.

9. The device according to claim 3, wherein said processing and control unit is configured to store in said at least one storage device at least one specific behavior said to be selected, associated with said input data for mapping.

10. The device according to claim 3, wherein said processing and control unit is configured to associate said at least one selected category with at least one specific behavior of said at least one mobile agricultural vehicle, based on automated instructions consisting of imposing at least one specific behavior said to be imposed from a set of possible specific behaviors for said at least one selected category.

11. The device according to claim 3, wherein the processing and control unit comprises at least one human-machine interface comprising a screen, and wherein the processing and control unit is configured to display on said screen at least one map of the plot of land comprising at least one real closed outline of the risky zone and/or one extended closed outline of the extended zone and said at least one selected category.

12. A control method for at least one mobile agricultural vehicle within a plot of land, wherein the method is implemented by the device according to claim 1 and the method comprises at least the following stages:
a risky zone, category and specific behavior storage stage, during which input data for mapping at least one risky zone located within at least one plot of land, data representative of a set of types of risky zone called categories and data representative of a set of specific behaviors of said at least one mobile agricultural vehicle are saved in at least one storage device contained in a processing and control unit of the device;
a first data association stage, in which said input data for mapping of at least one risky zone is associated with at least one category by said processing and control unit;
a second data association stage, in which said at least one category is associated with at least one specific behavior of said at least one mobile agricultural vehicle by said processing and control unit;
a control stage of the agricultural vehicle, during which said processing and control unit controls said specific behavior for said mobile agricultural vehicle if the position of said agricultural vehicle is in or near said at least one risky zone;
an autonomous moving stage of the agricultural vehicle in the plot of land, during which said mobile agricultural vehicle moves autonomously within the plot of land according to said at least one specific behavior controlled by said processing and control unit.

13. The method according to claim 12, wherein during the first data association stage, said processing and control unit associates the input data for mapping of at least one risky zone with at least one category based on selection instructions received by a user or a robot, consisting of selecting at least one category said to be selected from a set of possible predefined categories for said at least one risky zone or from a set of additional specific behaviors not contained in said set of possible specific behaviors for said at least one selected category.

14. The method according to claim 13, wherein during the second data association stage, said processing and control unit associates said at least one selected category with at least one specific behavior of said at least one mobile agricultural vehicle based on instructions received by a user or a robot, consisting of selecting at least one specific behavior said to be selected from a set of possible specific behaviors for said at least one selected category or from a set of additional specific behaviors not contained in said set of possible specific behaviors for said at least one selected category.

15. The method according to claim 13, wherein during the second data association stage, said processing and control unit associates said at least one selected category with at least one specific behavior of said at least one mobile agricultural vehicle, based on automated instructions consisting of imposing at least one specific behavior said to be imposed from a set of possible specific behaviors for said at least one selected category.
